(19) United States
(12) Patent Application Publication
(10) Pub. No.: US 2021/0105437 A1
(43) Pub. Date: Apr. 8, 2021

(54) INFORMATION PROCESSING DEVICE, INFORMATION PROCESSING METHOD, AND STORAGE MEDIUM

(71) Applicant: SHARP KABUSHIKI KAISHA, Sakai-City (JP)

(72) Inventors: SATOSHI TERADA, Sakai City (JP); KEIKO HIRUKAWA, Sakai City (JP); YOSUKE OSAKI, Sakai City (JP)

(21) Appl. No.: 17/035,636

(22) Filed: Sep. 28, 2020

(30) Foreign Application Priority Data
Oct. 7, 2019 (JP) 2019-184431

(51) Int. Cl. H04N 7/15; G06K 9/00; H04M 3/56

(52) U.S. Cl. CPC H04N 7/15; H04M 2201/405; H04M 3/568; G06K 9/00671

(57) ABSTRACT

An information processing device includes an image acquirer that acquires a captured image captured by an imager, an utterer identifier that identifies an utterer, a display target identifier that identifies a display target corresponding to the utterer identified by the utterer identifier from the captured image acquired by the image acquirer, and a display processor that displays display information corresponding to the display target identified by the display target identifier, on a first display.

### INCORPORATION BY REFERENCE

This application is based upon and claims the benefit of priority from the corresponding Japanese Patent Application No. 2019-184431 filed on Oct. 7, 2019, the entire contents of which are incorporated herein by reference.

### BACKGROUND OF THE INVENTION

### Field of the Invention

The present invention relates to an information processing device usable in a meeting, an information processing method therefor, and a storage medium therefor.

### Description of the Background Art

Conventionally, a meeting system is known in which voices, still or moving images, files, and the like are transmitted and received via a network in places separated from each other. For example, Japanese Unexamined Patent Application Publication No. 2010-55375 discloses a technology in which an image of a face of a meeting participant is captured with a camera, an utterer is identified based on the captured face image, the identified utterer is selectively captured, and a voice of the identified utterer is selectively collected.

However, in the conventional technology, for example, although the face image of an utterer may be displayed on a display installed in a meeting room R2 (at a remote location or the like) different from a meeting room R1 in which the utterer is present, it is difficult to display the face image of a partner to whom the utterer is speaking or an object (such as a product) explained by the utterer. This arises a problem that it is difficult for the meeting participants to understand the meeting content.

An object of the present invention is to provide an information processing device, an information processing method, and a storage medium, by which it is possible for meeting participants to easily understand a meeting content.

### SUMMARY OF THE INVENTION

An information processing device according to an aspect of the present invention includes an image acquirer that acquires a captured image captured by an imager, an utterer identifier that identifies an utterer, a display target identifier that identifies a display target corresponding to the utterer identified by the utterer identifier from the captured image acquired by the image acquirer, and a display processor that displays display information corresponding to the display target identified by the display target identifier, on a first display.

An information processing method according to another aspect of the present invention includes using one or more processors to execute acquiring a captured image captured by an imager, identifying an utterer, identifying a display target corresponding to the utterer identified in the identifying an utterer from the captured image acquired in the acquiring, and displaying display information corresponding to the display target identified in the identifying a display target, on a first display.

In a non-transitory storage medium for storing an information processing program according to another aspect of the present invention, the program causes one or more processors to execute acquiring a captured image captured by an imager, identifying an utterer, identifying a display target corresponding to the utterer identified in the identifying an utterer from the captured image acquired in the acquiring, and displaying display information corresponding to the display target identified in the identifying a display target, on a first display.

According to the present invention, there are provided an information processing device, an information processing method, and a storage medium, by which it is possible for a meeting participant to easily understand a meeting content.

### BRIEF DESCRIPTION OF THE DRAWINGS

FIG. 1 is a diagram illustrating a simplified configuration of a meeting system according to an embodiment of the present invention;

FIG. 2 is a functional block diagram illustrating a configuration of an information processing device according to the embodiment of the present invention;

FIG. 3 is a diagram illustrating an example of a captured image captured by the information processing device according to the embodiment of the present invention;

FIG. 4 is a diagram illustrating an example of a line-of-sight direction of an utterer in a meeting system according to the embodiment of the present invention;

FIG. 5 is a diagram illustrating an example of a captured image captured by the information processing device according to the embodiment of the present invention;

FIG. 6 is a diagram illustrating an example of a display screen of a display device according to the embodiment of the present invention;

FIG. 7 is a diagram illustrating an example of a display screen of the display device according to the embodiment of the present invention;

FIG. 8 is a diagram illustrating an example of a display screen of the display device according to the embodiment of the present invention;

FIG. 9 is a flowchart for explaining an example of a procedure of a display control process in the information processing device according to the embodiment of the present invention; and

FIG. 10 is a flowchart for explaining an example of a procedure of a display control process in the information processing device according to the embodiment of the present invention.

### DESCRIPTION OF THE PREFERRED EMBODIMENTS

An embodiment of the present invention will be described below with reference to the attached drawings. The following embodiment is an example in which the present invention is embodied, and does not intend to limit the technical scope of the present invention.

An information processing device according to the present invention is applicable to a meeting in which a plurality of users participate, a remote meeting in which a plurality of users in remote places connected via a network participate, and the like. The information processing device may be a camera device or a device having a camera function, a function of executing a voice command, and a voice communication function of performing voice communication among users. In the following embodiment, a case where the information processing device is applied to a remote meeting will be described as an example, and the information processing device includes a plurality of the information processing devices. In the remote meeting, the information processing devices are installed in various remote places (meeting rooms), and an information processing device in a first meeting room receives a voice output from a user and transmits the voice to an information processing device in a second meeting room to enable a conversation between the users in the meeting rooms. A captured image obtained by the information processing device in the first meeting room is displayed on a display device (display) installed in the second meeting room. In each of the meeting rooms, the information processing device receives a command voice from a user and transmits the command voice to a cloud server (not illustrated) that executes a predetermined command.

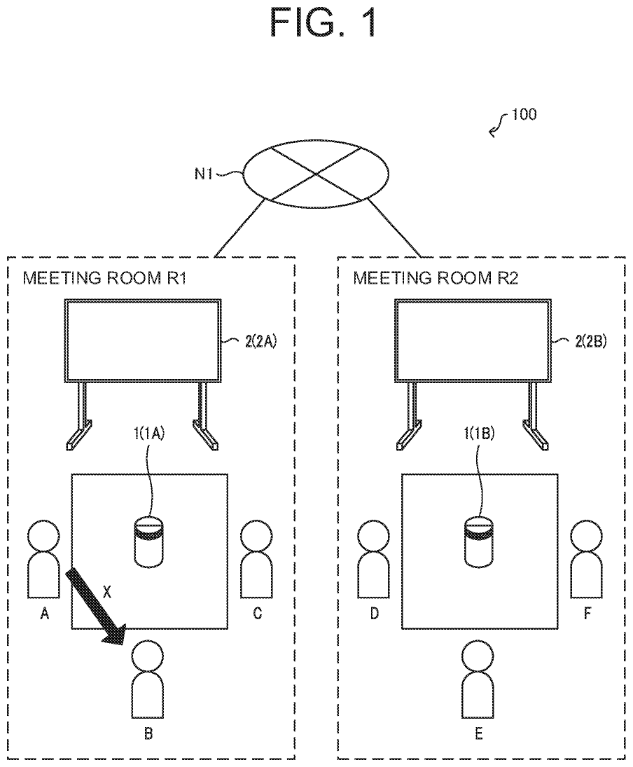

FIG. 1 is a diagram illustrating a simplified configuration of a meeting system according to an embodiment of the present invention. A meeting system 100 includes one or more information processing devices 1 and one or more display devices 2. Each of information processing devices 1A and 1B includes a camera, a microphone, and a speaker. Each of the information processing devices 1A and 1B may be, for example, an AI speaker and a smart speaker equipped with a camera function. In FIG. 1, the information processing device 1A installed in a meeting room R1 and the information processing device 1B installed in a meeting room R2 are illustrated. Each of display devices 2A and 2B is a display that displays various types of information. The information processing devices 1A and 1B and the display devices 2A and 2B are connected to each other via a network N1. The network N1 is a communication network such as the Internet, LAN, WAN, or a public telephone line. The information processing devices 1A and 1B are examples of an information processing device according to the present invention.

A specific configuration of the meeting system 100 will be described below. In the description that follows, the information processing devices 1A and 1B will be referred to as an information processing device 1 unless otherwise necessary and the display devices 2A and 2B will be referred to as a display device 2 unless otherwise necessary. The information processing devices 1A and 1B are the same in configuration. The information processing device 1A will be mainly described below as an example.

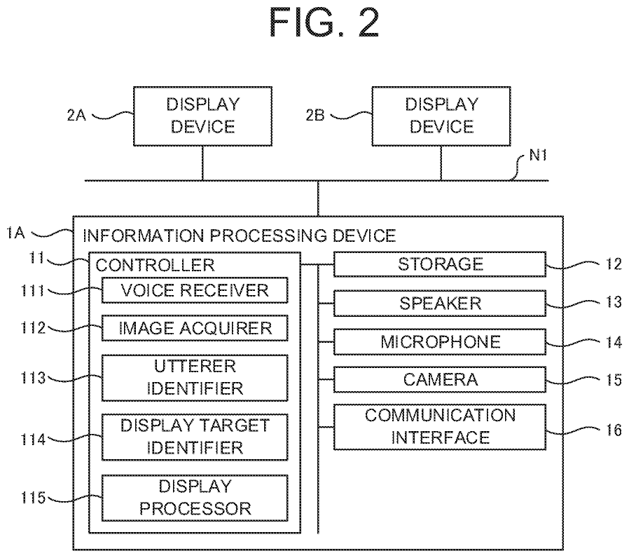

As illustrated in FIG. 2, the information processing device 1A includes a controller 11, a storage 12, a speaker 13, a microphone 14, a camera 15, and a communication interface 16. The information processing device 1A, which is placed, for example, at a certain location of a desk surface in the meeting room R1 as illustrated in FIG. 1, captures a face of a user participating in a meeting with the camera 15, acquires a voice of the user (utterer) through the microphone 14, and outputs the voice from the speaker 13 to the user, for example.

The camera 15 is a digital camera that captures an image of a subject and outputs the image as digital image data. For example, the camera 15 is provided on an upper portion of the information processing device 1A and captures an image within a 360-degree range around the information processing device 1A. In this example, the camera 15 captures an entire internal room image of the meeting room R1. The camera 15 is an example of an imager according to the present invention.

The communication interface 16 is a communication interface for connecting the information processing device 1A to the network N1 in a wired or wireless manner to execute data communication that complies with a predetermined communication protocol, with another device (the information processing device 1B, and the display device 2A and 2B, for example) via the network N1.

The storage 12 is a non-volatile storage including a flash memory, a hard disk drive (HDD), a solid state drive (SSD) in which various types of information are stored.

Specifically, the storage 12 stores data such as captured image data captured by the camera 15 and voice data collected by the microphone 14. The storage 12 may store display data of an image (of a meeting material and the like) displayed on the display devices 2A and 2B. It is noted that these data may be stored in a data server (not illustrated) connected to the network N1.

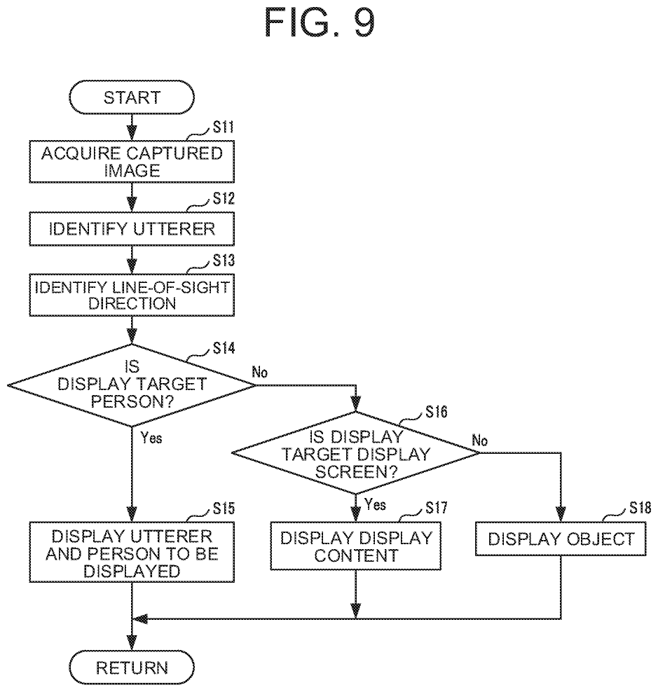

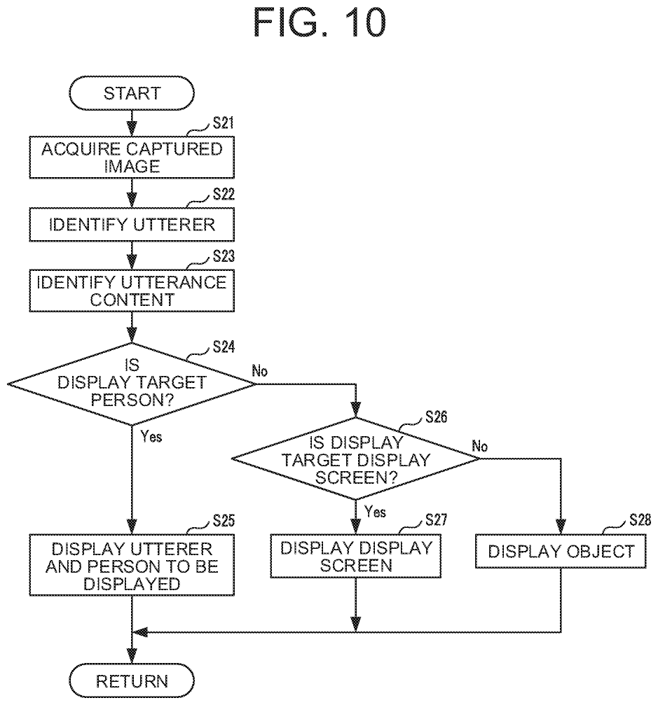

The storage 12 stores a control program such as a display program for causing the controller 11 to execute a display control process (see FIG. 9 and FIG. 10) described later. For example, the display control program is recorded non-temporarily on a computer-readable recording medium such as a USB, a CD or a DVD, and is stored in the storage 12 after being read by a reading device (not illustrated) provided in the information processing device 1A.

The controller 11 includes a control device such as a CPU, a ROM, and a RAM. The CPU is a processor that executes various types of arithmetic processes. The ROM stores in advance a control program such as BIOS and OS for causing the CPU to execute various types of processes. The RAM stores various information and is used as a temporary storage memory (working area) for various types of processes to be executed by the CPU. The controller 11 controls the information processing device 1A by causing the CPU to execute various types of control programs stored in advance in the ROM or the storage 12.

Specifically, the controller 11 includes various types of processing operators such as a voice receiver 111, an image acquirer 112, an utterer identifier 113, a display target identifier 114, and a display processor 115. The controller 11 functions as the various types of processing operators by causing the CPU to execute various types of processes according to the control programs. Some or all of the processing operators included in the controller 11 may include an electronic circuit. It is noted that the display control program may be program for causing a plurality of processors to function as the various types of processing operators.

The voice receiver 111 receives a voice uttered by a user who uses the information processing device 1A. The voice receiver 111 is an example of a voice receiver of the present invention. The user utters, for example, a voice regarding a content (agenda) of a meeting, a voice of a specific word (also referred to as an activation word or a wake-up word) for the information processing device 1A to start receiving a command, a voice of various commands (command voice) for instructing the information processing device 1A, and the like. For example, as illustrated in FIG. 1, the voice receiver 111 receives various voices uttered by users A, B, and C participating in a meeting in the meeting room R1.

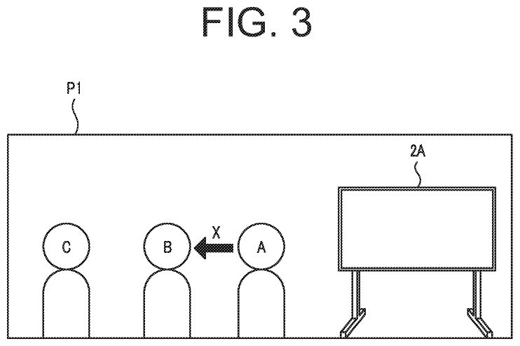

The image acquirer 112 acquires a captured image captured by the camera 15. The image acquirer 112 is an example of an image acquirer of the present invention. For example, in the meeting room R1 illustrated in FIG. 1, if images of the users A, B, and C and the display device 2A included in the 360-degree range around the information processing device 1A are captured by the camera 15, the image acquirer 112 acquires a captured image P1 (see FIG. 3) including the users A, B, and C and the display device 2A.

The utterer identifier 113 identifies a user (utterer) who utters. The utterer identifier 113 is an example of an utterer identifier of the present invention. Specifically, the utterer identifier 113 identifies an utterer, based on the captured image P1 acquired by the image acquirer 112. For example, the utterer identifier 113 identifies an utterer, based on movements of faces and mouths of the users A, B, and C included in the captured image P1.

The utterer identifier 113 may identify an utterer, based on the voice received by the voice receiver 111 and the captured image P1. For example, the utterer identifier 113 identifies a direction (utterer direction) in which the voice is received based on a direction in which the microphone 14 collects the voice, and identifies an utterer, based on the captured image P1 included in the direction. For example, if a user is included in the captured image P1 included in the direction, the utterer identifier 113 identifies the user as the utterer. This enables exact identification of the utterer.

The display target identifier 114 identifies a display target corresponding to the utterer identified by the utterer identifier 113, based on the captured image P1 acquired by the image acquirer 112. The display target identifier 114 is an example of a display target identifier of the present invention. The display target is, for example, a display target displayed on a display device 2B installed in the meeting room R2 different from the meeting room R1 in which the utterer is present, and includes the users A, B, and C (persons), the display screen of the display device 2A, and an object arranged in the meeting room R1 (such as a product and a meeting material serving as the agenda for the meeting). That is, the display target includes a partner to whom the utterer speaks and an object to be explained.

Specifically, the display target identifier 114 identifies a line-of-sight direction of the utterer, based on the captured image P1, and identifies the display target from the captured image P1, based on the identified line-of-sight direction. The display target identifier 114 can identify the line-of-sight direction by a well-known technique. FIG. 1 and FIG. 3 illustrate an example of a line-of-sight direction X of the user A identified as the utterer by the utterer identifier 113. The display target identifier 114 identifies the line-of-sight direction X of the user A, based on the captured image P1 illustrated in FIG. 3. The display target identifier 114 identifies, as the display target, the user B located in the identified line-of-sight direction X in the captured image P1.

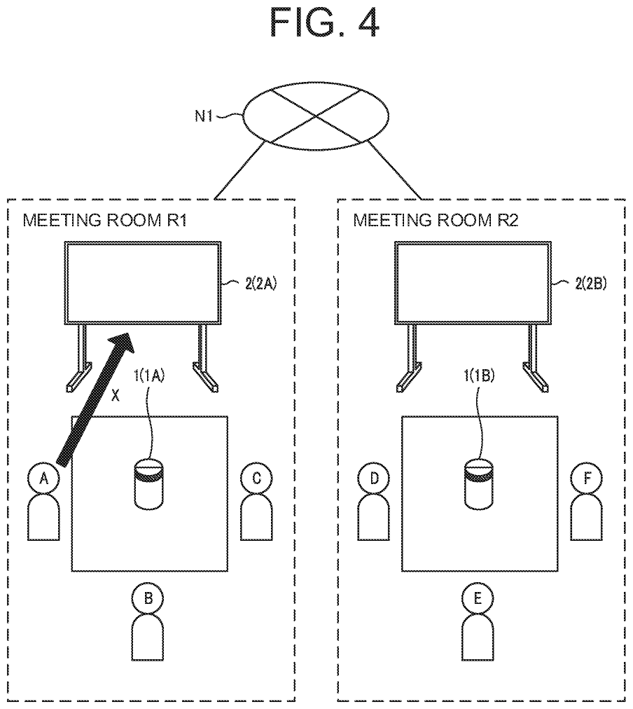

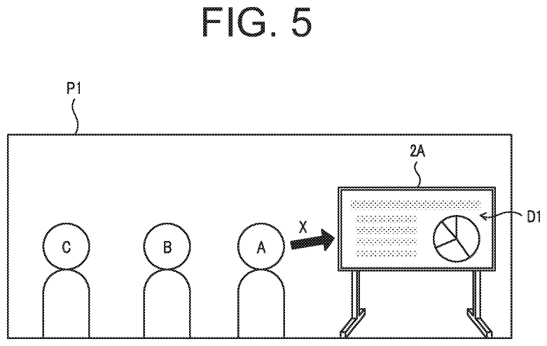

FIG. 4 and FIG. 5 illustrate another example of the line-of-sight direction X of the user A identified as the utterer by the utterer identifier 113. The display target identifier 114 identifies the line-of-sight direction X of the user A, based on the captured image P1 illustrated in FIG. 5. In the captured image P1, the display target identifier 114 identifies, as the display target, the display screen of the display device 2A located in the identified line-of-sight direction X. It is noted that on the display screen of the display device 2A, for example, information (a display content D1) of a meeting material (file) related to the agenda for the meeting is displayed. Here, for example, the user A explains the display content D1 while looking at the display screen of the display device 2A.

As another example, if there is, for example, a product (object) in the line-of-sight direction X of the utterer, the display target identifier 114 identifies the product as the display target in the captured image P1.

The display processor 115 displays, on the display devices 2A and 2B, the display information corresponding to the display target identified by the display target identifier 114. The display processor 115 is an example of a display processor according to the present invention.

The display processor 115 identifies a region of the display information. For example, if the display target identifier 114 identifies the user B as the display target, the display processor 115 identifies a predetermined region mainly featuring a face of the user A and a predetermined region mainly featuring a face of the user B. For example, if the display target identifier 114 identifies the display screen of the display device 2A as the display target, the display processor 115 identifies a region covering a whole of the display screen. For example, if the display target identifier 114 identifies an object (product) as the display target, the display processor 115 identifies a region of a whole of the object. If the display processor 115 identifies the region of the display information, the display processor 115 displays the display information on the display devices 2A and 2B, for example, as described below. The display device 2B is an example of the first display of the present invention, and the display device 2A is an example of a second display of the present invention.

The display processor 115 transmits data (image data, display data, and the like) corresponding to the display information to the display device 2B or the information processing device 1B. The display device 2B may receive the data from the information processing device 1A and display the received display information, or the information processing device 1B may receive the data from the information processing device 1A and display the received display information on the display device 2B.

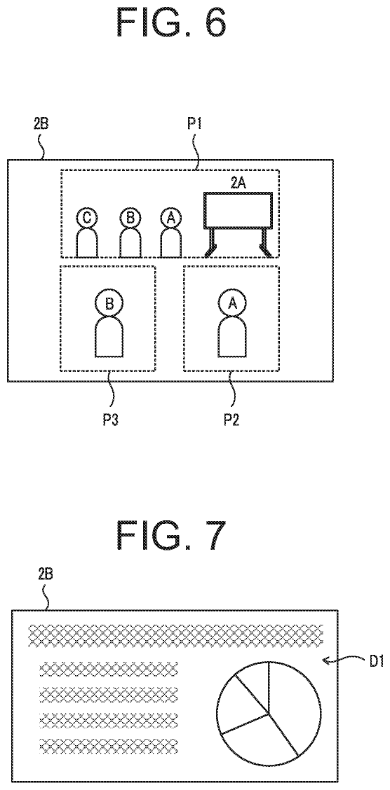

For example, if the display target identifier 114 identifies the user B as the display target, the display processor 115 displays, as illustrated in FIG. 6, a face image P2 of the user A being the utterer, and a face image P3 of the user B identified by the display target identifier 114, in a side-by-side manner, on the display device 2B (an example of the first display of the present invention). The display processor 115 may display the captured image P1 on the display device 2B in addition to the face images P2 and P3. This allows participants (users D, E, and F) in the meeting room R2 to recognize that the user A is speaking to the user B in the meeting room R1. The participants expect that the user B speaks after the user A speaks. In this case, the information processing device 1B acquires a voice of the user A received by the voice receiver 111 from the information processing device 1A and outputs the received voice in the meeting room R2. In addition to the face images P2 and P3, the display device 2A in the meeting room R1 also displays captured images obtained by capturing images of the users D, E, and F and the display device 2B in the meeting room R2.

In an example illustrated in FIG. 6, to facilitate collecting the voice of the user B identified by the display target identifier 114, the controller 11 may further set (adjust) a directivity (parameter) of the microphone 14 to the direction of the user B by using a beam forming technology and the like. This makes it possible to properly acquire the voice of the user B who may possibly speak next to the user A.

For example, if the display target identifier 114 identifies, as the display target, the display screen of the display device 2A, as illustrated in FIG. 7, the display processor 115 displays the display content D1 of a whole of the display screen identified by the display target identifier 114, on the display device 2B (an example of the first display of the present invention). Here, the display processor 115 may display the captured image of the whole of the display screen on the display device 2B, but the display processor 115 desirably displays the display content D1 on the display device 2B, based on the display data corresponding to the display content D1. As a result, an image quality of the display content D1 displayed on each of the display devices 2A and 2B may be consistent. The display device 2B may receive the display data from the information processing device 1A and display the display content D1, and the information processing device 1B may receive the display data from the information processing device 1A and display the display content D1 on the display device 2B. This allows the participants (users D. E, and F) in the meeting room R2 to easily recognize the contents (meeting materials) explained by the user A in the meeting room R1. In this case, the information processing device 1B acquires a voice of the user A received by the voice receiver 111 from the information processing device 1A and outputs the received voice in the meeting room R2. In this case, the display processor 115 does not need to display the face image P2 of the user A on the display device 2B.

For example, if the display target identifier 114 identifies, as the display target, a product (object) placed in the meeting room R1, the display processor 115 displays an image of a whole of the product identified by the display target identifier 114, on the display device 2B (an example of the first display of the present invention). This allows the participants (users D, E, and F) in the meeting room R2 to easily recognize the product explained by the user A in the meeting room R1. In this case, the information processing device 1B acquires a voice of the user A received by the voice receiver 111 from the information processing device 1A and outputs the received voice in the meeting room R2. In this case, the display processor 115 does not need to display the face image P2 of the user A on the display device 2B.

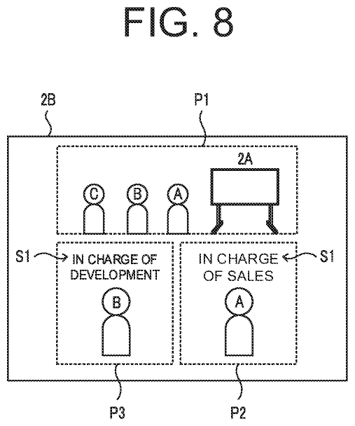

The display processor 115 may further display specific information corresponding to the display target identified by the display target identifier 114, on the display device 2B. For example, as illustrated in FIG. 8, the display processor 115 displays specific information S1 (“in charge of sales”, for example) corresponding to an attribute of the user A in the vicinity of the face image P2 of the user A, and displays specific information S1 (“in charge of development”, for example) corresponding to an attribute of the user B in the vicinity of the face image P3 of the user B. If the display target is the display screen (see FIG. 7), the display processor 115 displays a title (a meeting material name, a file name, and the like) of the display content D1, for example, as the specific information. If the display target is the product, the display processor 115 displays, for example, a product name as the specific information.

Display Control Process

An example of a procedure of a display control process executed by the controller 11 of the information processing device 1 will be described below with reference to FIG. 9. Here, in the meeting system 100 illustrated in FIG. 1, the display control process will be described with a focus on the information processing device 1A. For example, the controller 11 of the information processing device 1A starts execution of the display control program in response to receiving a voice of a user to start execution of the display control process. It is noted that the display control process is individually executed in parallel in each of the information processing devices 1A and 1B.

The present invention may be regarded as an invention of a display control process method in which one or more steps included in the display control process are executed. One or more steps included in the display control process described here may be omitted where appropriate. Each of the steps in the display control process may be executed in a different order as long as a similar operation and effect are achieved. Furthermore, although a case where each of the steps in the display control process is executed by the controller 11 will be described as an example herein, in another embodiment, each of the steps in the display control process may be dispersedly executed by a plurality of processors.

First, in step S11, the controller 11 acquires the captured image captured by the camera 15. Here, the controller 11 acquires the captured image P1 (see FIG. 3) including the three users A, B. and C present in the meeting room R1 (see FIG. 1) and the display device 2A. Step S11 is an example of acquiring a captured image according to the present invention.

Next, in step S12, the controller 11 identifies an utterer. For example, the controller 11 identifies an utterer, based on a movement of a face and a mouth of each of the users A, B, and C included in the captured image P1. Here, it is assumed that the user A is identified as the utterer. Step S12 is an example of identifying an utterer according to the present invention.

Next, in step S13, the controller 11 identifies a line-of-sight direction of the utterer. For example, the controller 11 identifies the line-of-sight direction X of the user A, based on the captured image P1.

Next, in step S14, the controller 11 identifies the display target, based on the line-of-sight direction. Specifically, the controller 11 determines whether the display target is a person. For example, the controller 11 determines, in the captured image P1, whether the display target (object image) located in the identified line-of-sight direction X is a person. If the display target is a person (S14: Yes), the process proceeds to step S15. If the display target is not a person (S14: No), the process proceeds to step S16. In an example illustrated in FIG. 3, the controller 11 determines that the display target is a person.

In step S15, the controller 11 identifies a predetermined region mainly featuring a face of the utterer and a predetermined region mainly featuring a face of the person identified as the display target. Here, the controller 11 identifies a predetermined region corresponding to the user A being the utterer and a predetermined region corresponding to the user B being the display target. The controller 11 displays images corresponding to the identified predetermined regions, on the display devices 2A and 2B. For example, as illustrated in FIG. 6, the controller 11 displays the face image P2 of the user A and the face image P3 of the user B, on the display device 2B.

In step S16, the controller 11 determines whether the display target identified based on the line-of-sight direction is a display screen. For example, the controller 11 determines, in the captured image P1, whether the display target (object image) located in the identified line-of-sight direction X is the display screen of the display device 2A. If the display target is the display screen (S16: Yes), the process proceeds to step S17. If the display target is not the display screen (S16: No), the process proceeds to step S18. In an example illustrated in FIG. 5, the controller 11 determines that the display target is the display screen. Steps S14 and S16 are examples of identifying a display target according to the present invention.

In step S17, the controller 11 identifies a whole region of the display screen of the display device 2A. The controller 11 displays a display content of the whole of the identified display screen, on the display device 2B. For example, as illustrated in FIG. 7, the controller 11 transmits, to the information processing device 1B, the display data corresponding to the display content D1 displayed on the display screen of the display device 2A, and causes the information processing device 1B to execute the display process of displaying the display content D1 on the display device 2B.

In step S18, the controller 11 identifies a whole region of the object (a product or the like) being the display target identified based on the line-of-sight direction. The controller 11 displays an image of a whole of the identified object, on the display device 2B.

If the processes of steps S15, S17, and S18 are completed, the above-described display control process is repeated. Steps S15, S17, and S18 are examples of displaying display information according to the present invention.

As described above, the information processing device 1 according to the embodiment of the present invention identifies a display target (a partner to whom an utterer speaks, a display screen, an object, and the like) corresponding to an utterer, based on a captured image captured by the camera 15, and displays display information (a face image, a display content, and the like) corresponding to the identified display target, on the display device 2. This allows a participant participating in a meeting at a remote location, for example, to visually recognize information intended by the utterer in the display device 2 at a remote location, and thus, it is possible to easily understand the meeting content.

The information processing device according to the present invention is not limited to the above embodiment, and the following embodiments may be applied.

In the information processing device 1 according to another embodiment, the display target identifier 114 identifies a display target from the captured image P1, based on an utterance content corresponding to the voice of an utterer received by the voice receiver 111. For example, if the utterance content includes identification information (a name, and the like) of the user B, the display target identifier 114 identifies the user B as the display target from the captured image P1.

For example, if the utterance content includes a keyword (the agenda, a meeting material name, and the like) related to the display content D1 displayed on the display device 2A, the display target identifier 114 identifies, as the display target, the display screen of the display device 2A from the captured image P1.

For example, if the utterance content includes a keyword (a product name, and the like) related to a product (object) placed in the meeting room R1, the display target identifier 114 identifies, as the display target, the product from the captured image P1.

FIG. 10 is a flowchart illustrating an example of a display control process corresponding to the other embodiment. The processes other than those in steps S23, S24, and S26 illustrated in FIG. 10 are the same as the processes shown in FIG. 9.

In step S23, the controller 11 identifies an utterance content corresponding to the voice of an utterer. For example, the controller 11 identifies an utterance content by a well-known voice recognition technology.

In step S24, the controller 11 determines whether the display target is a person, based on the identified utterance content. For example, the controller 11 determines that the display target is a person if the utterance content includes the name and the like of the user B.

In step S26, the controller 11 determines whether the display target is a display screen, based on the identified utterance content. For example, the controller 11 determines that the display target is a display screen if the utterance content includes a keyword (the agenda, a meeting material name, and the like) related to the display content D1 displayed on the display device 2A. For example, the controller 11 determines that the display target is an object if the utterance content includes a keyword (a product name and the like) related to an object (product) (S26: No).

Thus, the display target identifier 114 may identify a display target from the captured image P1, based on the utterance content of the utterer without considering the line-of-sight direction of the utterer. In this configuration, a keyword corresponding to the display target is previously stored in the storage 12, and the controller 11 identifies the display target, based on a keyword included in the utterance content.

In another embodiment of the present invention, the display target identifier 114 may identify the display target from the captured image P1, based on the line-of-sight direction of the utterer and the utterance content corresponding to the voice of the utterer. For example, if the user B is present in the line-of-sight direction X of the utterer, and if the utterance content includes the name of the user B, the display target identifier 114 identifies the user B as the display target.

For example, if there is any one of the users in the line-of-sight direction X of the utterer, and if the utterance content includes the display content D1 or a keyword of the product, the display target identifier 114 identifies the display content D1 or the product as the display target. Here, the display target identifier 114 identifies the display target by preferentially using the utterance content rather than the line-of-sight direction X.

It is noted that the display target identifier 114 may determine the priority of the line-of-sight direction and the utterance content depending on a time during which the line-of-sight direction X is directed. For example, if the line-of-sight direction X directs the user B for a predetermined time period or more, even when the utterance content includes the display content D1 or the keyword of the product, the display target identifier 114 identifies the user B as the display target by preferentially using the line-of-sight direction X rather than the utterance content.

If a display target is displayed on the display device 2B, based on the line-of-sight direction X of the utterer, the display content of the display device 2B changes every time the line-of-sight direction X of the utterer changes, and thus, this may make a user of the display device 2B to feel annoying. Therefore, in another embodiment of the present invention, the display processor 115 may continuously display the display information on the display device 2B until a predetermined time period passes or until the display target is identified by the display target identifier 114 since the display information is displayed on the display device 2B. For example, as illustrated in FIG. 6, even if the line-of-sight direction X of the user A being the utterer deviates from the user B after the face image P3 of the user B is displayed on the display device 2B, the display processor 115 displays the face image P3 of the user B on the display device 2B continuously for a predetermined time period. Accordingly, for example, even if the user A speaks to the user B while looking at a different direction from that of the user B, it is possible to appropriately display, as the display target, the user B on the display device 2B. In the case, if the display target identifier 114 identifies, as the display target, the display screen (display content D1) of the display device 2A, the display processor 115 changes the display information of the display device 2B from the face image P3 of the user B to the display content D1.

In the above-described embodiment, the information processing device 1 corresponds to the information processing device according to the present invention, but the information processing device according to the present invention is not limited to this. For example, the information processing device according to the present invention may be configured by a management server (not illustrated) alone, or may be configured by the information processing device 1 and a management server. The management server is configured to include at least one of a plurality of processing operators (the voice receiver 111, the image acquirer 112, the utterer identifier 113, the display target identifier 114, and the display processor 115) included in the controller 11.

Each of the camera 15, the microphone 14, and the speaker 13 may be configured separately from the information processing device 1 and connected to the information processing device 1 via the network N1. In this case, for example, the camera 15, the microphone 14, and the speaker 13 are installed in each meeting room. The information processing device 1 is installed outside the meeting room and functions as a management server that manages the camera 15, the microphone 14, and the speaker 13 in each meeting room.

It is noted that, in the information processing device according to the present invention, within the scope of the invention described in claims, the embodiments described above may be freely combined, or the embodiments may be appropriately modified or some of the embodiments may be omitted.

### DESCRIPTION OF REFERENCE NUMERALS

1: Information processing device
2: Display device
14: Microphone
15: Camera
100: Meeting system
111: Voice receiver
112: Image acquirer
113: Utterer identifier
114: Display target identifier
115: Display processor

What is claimed is:

1. An information processing device comprising:
an image acquirer that acquires a captured image captured by an imager;
an utterer identifier that identifies an utterer;
a display target identifier that identifies a display target corresponding to the utterer identified by the utterer identifier from the captured image acquired by the image acquirer; and
a display processor that displays display information corresponding to the display target identified by the display target identifier, on a first display.

2. The information processing device according to claim 1, wherein the display target identifier identifies a line-of-sight direction of the utterer, based on the captured image, and identifies the display target from the captured image, based on the identified line-of-sight direction.

3. The information processing device according to claim 1, further comprising a voice receiver that receives a voice, wherein
the display target identifier identifies the display target from the captured image, based on an utterance content corresponding to the voice received by the voice receiver.

4. The information processing device according to claim 1, further comprising a voice receiver that receives a voice, wherein
the display target identifier identifies a line-of-sight direction of the utterer, based on the captured image, and identifies the display target from the captured image, based on the identified line-of-sight direction and an utterance content corresponding to the voice received by the voice receiver.

5. The information processing device according to claim 1, wherein if the display target identified by the display target identifier is a person different from the utterer, the display processor displays an image of the utterer included in the captured image and an image of the person, on the first display in a side-by-side manner.

6. The information processing device according to claim 1, wherein if the display target identified by the display target identifier is an object, the display processor displays an image of the object included in the captured image, on the first display and does not display an image of the utterer included in the captured image, on the first display.

7. The information processing device according to claim 1, wherein if the display target identified by the display target identifier is a display screen of a second display, the display processor displays a display content displayed on the display screen, on the first display, based on display data corresponding to the display content.

8. The information processing device according to claim 5, wherein the display processor further displays identification information corresponding to the display target identified by the display target identifier, on the first display.

9. The information processing device according to claim 5, wherein a directivity of a microphone that collects a voice is set to a direction of the person.

10. The information processing device according to claim 1, wherein the display processor continuously displays the display information on the first display since the display information is displayed on the first display until a predetermined time period passes or a display target different from the display target is identified by the display target identifier.

11. An information processing method comprising using one or more processors to execute:
acquiring a captured image captured by an imager;
identifying an utterer;
identifying a display target corresponding to the utterer identified in the identifying an utter from the captured image acquired in the acquiring; and
displaying display information corresponding to the display target identified in the identifying a display target, on a first display.

12. A non-transitory storage medium for storing an information processing program for causing one or more processors to execute:
acquiring a captured image captured by an imager;
identifying an utterer;
identifying a display target corresponding to the utterer identified in the identifying an utter from the captured image acquired in the acquiring; and
displaying display information corresponding to the display target identified in the identifying a display target, on a first display.
